(19) United States
(12) Patent Application Publication
(10) Pub. No.: US 2012/0030164 A1
(43) Pub. Date: Feb. 2, 2012

(54) METHOD AND SYSTEM FOR GATHERING AND USAGE OF LIVE SEARCH TRENDS

(75) Inventors: Hari Krishna Gutlapalli, Union City, CA (US); Suhas Rohit Mehta, Santa Clara, CA (US)

(73) Assignee: Oracle International Corporation, Redwood Shores, CA (US)

(21) Appl. No.: 12/844,230

(22) Filed: Jul. 27, 2010

(51) Int. Cl. G06F 17/30

(52) U.S. Cl. 707/603; 707/E17.107

(57) ABSTRACT

A system, method and computer readable storage medium is provided for collecting search requests from a variety of sources, analyzing those search requests in order to determine current trends in searches and other interne entries, and utilizing the search trend information to make enterprise data available to searching users through one or more access methods. One or more listening posts associated with a variety of data store sites accessible to searching users are configured to gather and perform initial filtering of the search requests to the associated sites and other entries. The search request information and other entry information is transmitted to one or more analysis servers that perform additional analysis of key words and phrases in order to categorize and score the searches and entries. Data mining techniques are then used to determine search trends of value to the enterprise performing such search trend analysis.

### FIELD OF THE INVENTION

Embodiments of the present invention relate generally to the field of computer data searching and, more specifically, to identification of search trends and use of such information by an enterprise-class organization.

### BACKGROUND OF THE INVENTION

Data sources coupled to wide-area networks such as the Internet provide an opportunity for a connected user to access an ever-increasing amount of information. This information is generally structured and organized in manners specific to each entity that collects and disseminates their information. This varied structure and organization can make accessing that information by a typical user difficult.

A typical user may seek aid in accessing the varied types of information available to them by using search provider entities such as GOOGLE and YAHOO. These search providers number among some of the most visited sites on the Internet. A user of a search provider can submit a search request consisting of a quoted string or set of key words, and expect a significant number of links to sites having information that may be of interest. But reviewing the results of such searches can be inefficient because important information to a user can be buried in the results of the search.

In addition, even though a large amount of information is publicly available to a searcher, important information can also be located within private enterprise networks and not accessible to an outside searcher. There may be value to the enterprise having such information, and the searcher, if this information can be proactively made available before the user seeks it. For example, an enterprise can make available information responsive searches popular on the Internet on that enterprise's website or via a web service. Or customer response management systems can make that information available to agents who may respond to a query.

It is therefore desirable to have a system that can determine current search trends by network searches. It is further desirable to use that search trend information to organize search results in a manner that places result items having information matching or responsive to current search trends near the top of search result lists. It is also desirable to use search trend information to make available internal enterprise data to external users, either through a web service or service agents. By making such information available, agents can spend less time searching for such information and, in the case of web-available information, increase a number of “hits” on the enterprise's website. An enterprise can also use such search trend information to proactively improve sales and service requests.

### SUMMARY OF THE INVENTION

Embodiments of the present invention provide a system for collecting search requests from a variety of sources, analyzing those search requests in order to determine current trends in searches, and utilizing the search trend information to make enterprise data available to searching users through one or more access methods. One embodiment of the present invention provides for capturing the search phrase, analyzing the search phrase for one or more relationships with one or more previously captured search phrases, generating relationship information from the analysis, and storing relationship information in a trend database. One aspect of the above embodiment is the search phrase comprising one or more keywords and strings.

A further aspect of the above embodiment provides for performing the capturing using a first node, performing a filtering of the search phrase for information of interest by the first compute node, and having the first compute node transmit to a second compute node the search phrase if it does contain the information of interest. The information of interest can be preconfigured in the first compute node.

Another aspect of the above embodiment provides for performing the analyzing by a second node. That analyzing includes categorizing the search phrase using previously determined categories from previous search phrases, filtering the search phrase for one or more categories of interest, and generating trend data for the search phrase in light of the categorizing. A further aspect of this embodiment provides for storing one or more of the trend data and the search phrase in a multidimensional database. Another aspect of this embodiment provides for generating a score associated with the search phrase, in which the score is dependent upon a number of categories generated by the categorizing.

The foregoing is a summary and thus contains, by necessity, simplifications, generalizations and omissions of detail. Consequently, those skilled in the art will appreciate that the summary is illustrative only and is not intended to be in any way limiting. Other aspects, inventive features, and advantages of the present invention, as defined solely by the claims, will become apparent in the non-limiting Detailed Description set forth below.

### BRIEF DESCRIPTION OF THE DRAWINGS

The present invention may be better understood, and its numerous objects, features and advantages made apparent to those skilled in the art by referencing the accompanying drawings.

FIG. 1 is a simplified block diagram illustrating a traditional network of searchable data stores and an additional enterprise data network.

FIG. 2 is a simplified block diagram illustrating an example of a network environment in which search and posting information can be provided to an enterprise and be acted upon, in accord with embodiments of the present invention.

FIG. 3 is a simplified flow diagram illustrating a process performed by listening posts in capturing search and post information at data stores, in accord with embodiments of the present invention.

FIG. 4 is a simplified flow diagram illustrating organization of search query results in light of search trend information provided by embodiments of the present invention.

FIG. 5 is a simplified flow diagram illustrating use of trend information to make selected enterprise data available externally to the enterprise, in accord with embodiments of the present invention.

FIG. 6 illustrates generation of a user search profile in conjunction with gathering of current trend information, in accord with embodiments of the present invention.

FIG. 7 illustrates an alternative process for utilizing information in a user search profile, in accord with embodiments of the present invention.

FIG. 8 is a simplified block diagram illustrating a customer relationship management architecture usable in conjunction with embodiments of the present invention.

FIG. 9 depicts a block diagram of a computer system suitable for implementing aspects of the present invention.

FIG. 10 is a block diagram depicting a network architecture suitable for implementing aspects of the present invention.

### DETAILED DESCRIPTION

Embodiments of the present invention provide a system for collecting search requests from a variety of sources, analyzing those search requests in order to determine current trends in searches, and utilizing the search trend information to make enterprise data available to searching users through one or more access methods. Embodiments of the present invention provide for one or more listening posts associated with a variety of data store sites accessible to searching users. The listening posts gather and perform initial filtering of search requests to those sites. Embodiments of the present invention further provide for transmitting such search request information to one or more analysis servers that can perform additional analysis of search key words and phrases in order to categorize and score those searches. Embodiments of the present invention further use data mining techniques to determine search trends of value to the enterprise performing such search trend analysis. Once search trend data is captured and analyzed, embodiments of the present invention further provide for a variety of mechanisms by which the enterprise can utilize such information, thereby making available data responsive to future search requests in an efficient and ready manner.

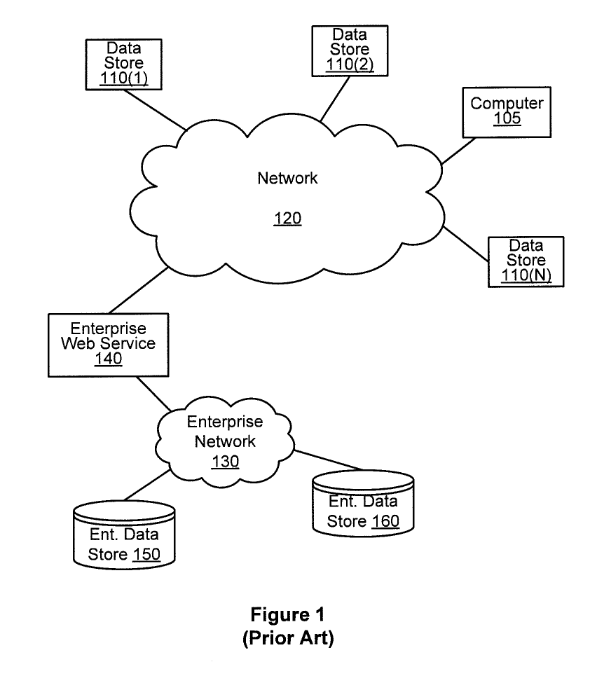

FIG. 1 is a simplified block diagram illustrating a traditional network of searchable data stores and an additional enterprise data network. A computer 105 and a set of searchable data stores 110(1)-(N) are coupled to a network 120. A searching user on computer 105 can access information stored on any of data stores 110 through a variety of communication protocols supported by network 120. Data stores 110(1)-(N) can each take a variety of different forms, including, for example, a file repository, a database, a blog server, a chat room server, and the like. Embodiments of the present invention are not limited by the nature of data stores 110(1)-(N), as will be discussed in greater detail below. In the context of the present invention, network 120 can be a wide area network generally available to a large number of computers 105 (e.g., the Internet), a metro-area network available to a number of users in a geographically limited context, a local area network, or a combination of the above. Network 120 can also provide such communications over a variety of protocols, and embodiments of the present invention are not limited to any particular network type or protocol.

FIG. 1 further illustrates an enterprise network 130 that is coupled to network 120 via an enterprise web service 140. Enterprise network 130 is representative of a private network for which the communications and data within is not generally available to an unauthorized computer on network 120. To the extent that data stored by computers in enterprise network 130 is made available to user computers on network 120, such a user computer would either be authorized or can access data that is made available via enterprise web service 140. Similar to data stores 110, enterprise web service 140 can provide data to computers 105 using a number of protocols for searchable and browsable data stores. Enterprise network 130 can also have a number of internally accessible data stores (e.g., data stores 150 and 160). Such data stores can take a number of forms, including, for example, file systems, databases, and other business objects. Generally, data stored in data stores 150 and 160 is not accessible to an unauthorized computer external to enterprise network 130.

A user on computer 105 who is searching for specific information on one or more data stores 110 will commonly submit a search request to a search engine associated with a particular data store. A search request can include one or more search key words or quoted phrases. The key words and quoted phrases can be linked together using, for example, Boolean expressions. Search formats are determined by the particular search engine being used and the nature of the data being stored and searched on the data store. A searching user can also opt to do a more global search by accessing, for example, a search engine associated with a web crawler that gathers information about data stored in a number of data stores and which can provide a list of links responsive to a query.

On a daily basis, depending on the nature of a data store, tens of thousands of search requests can be made to each data store. Further, many comments and other types of posts can be made to data stores that have such a capability (e.g., a blog server). These posts and searches may be of interest to a business entity. For example, searches can be related to problems with or praise for products developed and sold by the business entity. The nature of such search requests may alert the business entity to potential problems with their product or the desire for more information about a particular product or service. In such cases, the business entity may already have information responsive to the search requests that cannot be accessed by a searching user because such information is stored, for example, in data stores 150 and 160. A business entity may wish to use such information to make available that type of data via an enterprise web service 140, for example. Alternatively, search and posting information can also be useful to an enterprise-type business entity in the context of sales. For example, if there is positive “buzz” for an announced product or, conversely, negative commentary regarding an announced product.

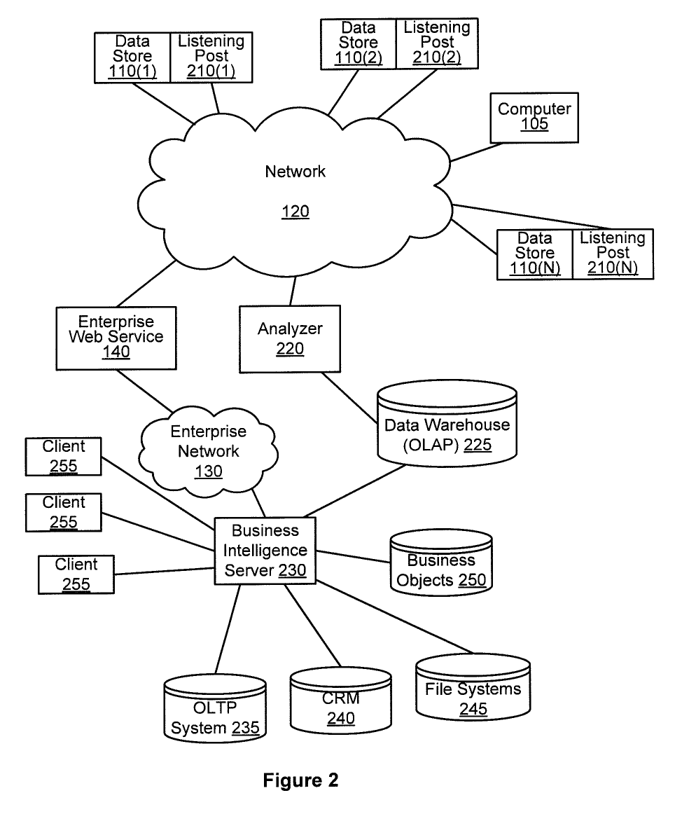

FIG. 2 illustrates an example of a network environment in which search and posting information can be provided to an enterprise and be acted upon, in accord with embodiments of the present invention. As with FIG. 1, a set of data stores 110(1)-(N) are coupled to a network 120 along with a computer 105. In addition, an enterprise network 130 is also coupled to network 120 via enterprise web service 140.

FIG. 2 also provides for listening posts 210(1)-(N) to be associated with each data store 110(1)-(N). A listening post constantly reads incoming search requests to the associated data store. A listening post can be a background program running on a server associated with each data store 110 (e.g., a daemon thread). A listening post constantly reads the incoming search strings and can send those search strings to an analyzer server 220 associated with the enterprise-type business entity. A listening post program can also provide a first level of filtering of search strings. For example, a listening post can be configured to only transmit search requests to the analyzer that are associated with a particular key word or subject. Alternatively, the filter can be configured to only transmit post information from a subset of trusted or authoritative sources associated with the particular data store. A listening post 210 does not interfere with normal search operations of the associated data store, but instead merely gathers a copy of search key words or phrases, or posts to the associated data store. The listening post can be configured to immediately provide search information to analyzer 220 or can gather search key words for a period of time and periodically provide gathered search information to the analyzer.

Analyzer 220 can take the form of one or more processes running on a computer coupled to network 120. The analyzer system can be directly coupled to network 120 or coupled to enterprise network 130 and subsequently connected to network 120 by a router or other means. Analyzer 120 gathers all search data provided to the analyzer by the various listening posts 210. Each search can be semantically analyzed for relevant subject matter and grouped with other searches having like subject matter. Each search can also be scored for potential relevance in that subject matter. For example, a score can be dependent upon a number of categories of interest being tracked that are present in the search string. Alternatively, the score can be dependent upon how often a particular category in the search string has been present in other search strings tracked; thus providing a measure of current relevance of the search string category. These categories can be derived from previous search strings analyzed, which may be flagged for further tracking. Analyzer 220 can also perform a second level of filtering of the search requests. Those search requests which are considered not of importance to the enterprise performing the search collection and analysis can be discarded at this stage. Once filtered, analyzer 220 can provide the search information to a data warehouse 225, where further trend analysis can be performed.

Data warehouse 225 is a data mining data store configured to analyze search data for trends in a variety of dimensions. In one embodiment, data warehouse 225 is a multidimensional database such as, for example, an online analytical processing (OLAP) database. Through the use of such a multidimensional database, search data can be organized into a variety of dimensions that are of import to different business segments of the enterprise collecting the search data. For example, one dimension can represent products of the enterprise, another dimension can represent time of various searches being conducted, another dimension can represent a scale of positive or negative impression of the product being discussed (as assessed by the analyzer), and the like. The nature of dimensions defined in data warehouse 225 can be determined by the needs of the enterprise performing the collection of search data, and embodiments of the present invention are not limited to those dimensions discussed herein. Through the use of such a multidimensional data store, a variety of calculations become available to the business entity (e.g., aggregations that roll up values based upon levels organized in dimensional hierarchies, time series calculations, intra dimensional calculations, cross dimensional calculations, procedural calculations in which rules are defined, ranking and hierarchical relationship calculations, and other types of calculations defined by the business entity itself).

As discussed above, among the reasons for implementing a search/post analysis system of the present invention is to enable the enterprise collecting the data to be responsive to search trends and the issues represented by such searches and/or posts in a timely manner. One mechanism for providing such responsiveness is to incorporate collection of such information into a business intelligence architecture of the enterprise. Business intelligence supports an organization's ability to create, maintain, analyze, and report accurate information about the business entity, and use that information for forward facing activities such as budgeting and forecasting. Business intelligence can also provide dashboards and score cards for business reporting that rely upon current data of importance to the organization. Such information includes predictive analytics that examine historical data using statistical tools and techniques, including data mining, to forecast or predict future events and to determine factors that best predict an event.

An example of an event that embodiments of the present invention are designed to avert is an overload of a customer response center due to unexpected problems with a product of the business entity. If a business entity learns of such problems through analysis of searches being conducted by various users, then information related to those problems can be made more readily available to users either online or via customer response agents who have been given a warning that such information may be of use.

FIG. 2 illustrates a business intelligence server 230 coupled to data warehouse 225 and other enterprise data sources, for example, an online transaction processing system 235, a customer response management system 240, file systems 245 and other business objects 250. Business intelligence server 230 can generate queries optimized for each data source and then aggregate responses to the queries, and present results to users (e.g., clients 255) using an appropriate user interface (e.g., dashboards and reports). Data and metadata for each of the data sources is available to the business intelligence server for querying and aggregating the data, even if in disparate data sources. A business intelligence server 230 can include more than one physical server to perform queries and aggregation in a timely manner. Multiple servers can also be clustered to provide such a replication and automatic fail over capabilities. The nature of the information provided to clients 255 by business intelligence server 230 will be discussed in more detail below.

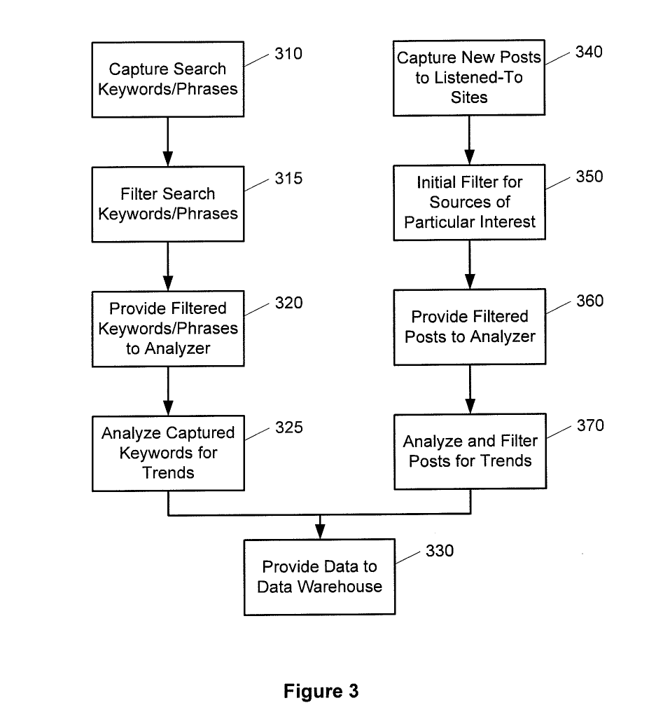

FIG. 3 is a simplified flow diagram illustrating a process performed by listening posts 210 in capturing search and post information at data stores 110, in accord with embodiments of the present invention. A listening post can be configured to capture search key words and also new posts that are provided to blog sites and the like, depending upon the nature of the associated data store. The listening post can capture search key words provided to data store 110 (310). As discussed above, a listening post can perform such activity as a background daemon process that constantly reads incoming search requests. An initial filtration of the search key words can optionally be performed by the listening post (315). Such initial filtration can be used to eliminate any search phrases containing key words that are generally not of interest to the enterprise or to specifically include search words that are of interest to the enterprise. Once filtered, if such filtration is desired, the collected search phrases can then be transmitted by the listening post to a central collection point (e.g., analyzer 220) (320). Each listening post on the network can provide the collected search data to a single collection point or to several collection points that can then store data in a central data store (e.g., data warehouse 225). The supplied key words can then be analyzed and filtered (e.g., by analyzer 220) in a manner desirable by the enterprise performing the search data collection (325). Such analysis can include trend analysis, scoring analysis, and the like, as discussed above. Once analyzed, the analyzed data and results can then be provided to a data warehouse (e.g., 225) for additional dimensional analysis, as discussed above (330).

In parallel with search phrase collection, a listening post associated with another data store 110 that provides a posting or commenting facility can in parallel capture new posts to the data store (340). Again, an initial filtration of these posts can be performed by the listening post (350). Such an initial filtration can include only providing data regarding posts by authoritative sources of information (e.g., specific user names or other business entities) or for particular topics of interest to the business entity. The filtered post information can then be provided to a central collection point (e.g., analyzer 220) (360). The central data collection point for posting information need not be the same central collection point as used for search queries and, instead, can be optimized for analysis of postings. Once centrally collected, post information can be analyzed for trends and an additional filtration can occur for particular subject matter of interest (370). Post trend information can then be provided to a data warehouse for collection and dimensional analysis as with key word data (330).

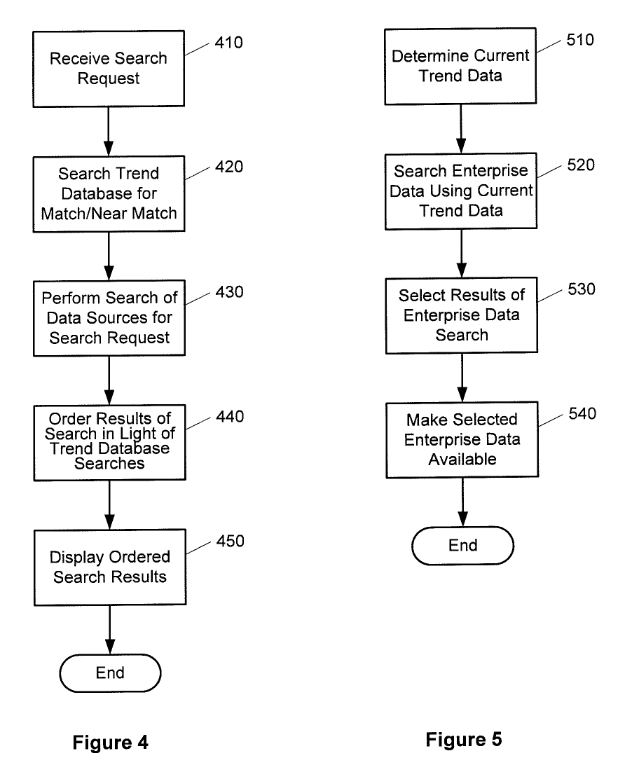

Once information regarding search trends and posting trends has been collected, a business entity can use that information in a variety of ways to improve efficiency of dissemination of information to the public and to customer representatives within the business entity. FIGS. 4 through 7 illustrate examples of how business entity can use the collected trend information in manners to more efficiently present and provide information to customers of the business entity.

FIG. 4 is a simplified flow diagram illustrating organization of search query results in light of search trend information provided by embodiments of the present invention. A search request can be received by a server within the business entity (410). An example of a server receiving such a search request can be a customer response management server (e.g., CRM 240) receiving a request from either an external user through a web service or by a customer response agent from a site internal to the enterprise. Data warehouse 225 or another search trend database can be searched, either directly or through business intelligence server 230, for trending searches that match or nearly match the received search request (420). A search of enterprise data sources (e.g., OCTP 235, File Systems 245, and Business Objects 250) can then be performed, or performed in parallel with the trend database search, for data responsive to the search request (430). The results of that search can then be organized in light of the most popular searches revealed from the trend database (440). In other words, the set of results generated by the search of data sources is analyzed in light of the trending searches and those results that are responsive to the trending searches can be listed first for the requesting user. The search results can then be displayed for the searching user using an appropriate user interface (450). In this manner, a business entity can anticipate information for which a user may be most interested, based upon the nature of currently trending queries by many other users. Thus, for example, a customer response agent will have results that may most nearly match issues being presented by a customer near the top of the ordered list and therefore will be able to respond to the customer in a quicker and more efficient manner.

FIG. 5 is a simplified flow diagram illustrating use of trend information to make selected enterprise data available externally to the enterprise, in accord with embodiments of the present invention. As discussed above, through the collection of search information and post information, a determination can be made of current trends regarding products or information that the enterprise may have (510). In light of the current trend data, enterprise data sources (e.g., 235, 240, 245 and 250) can be searched for documents or other information responsive to the currently trending searches (520). Results of this search can be selected to be made available to the enterprise's customer base (530). The enterprise can then make that selected enterprise data available (540). This availability can be provided by making a document available, for example, either on the enterprise's website or other publicly searchable sites. In addition, selected enterprise data can be made available to customers or agents using the enterprise's customer response management system. Alternatively, if responsive information is not in a form that can be usable by a customer, the enterprise can choose to generate documents that are usable based upon such information. For example, enterprise data can be in the form of a table or records within a database that may need translating for public consumption.

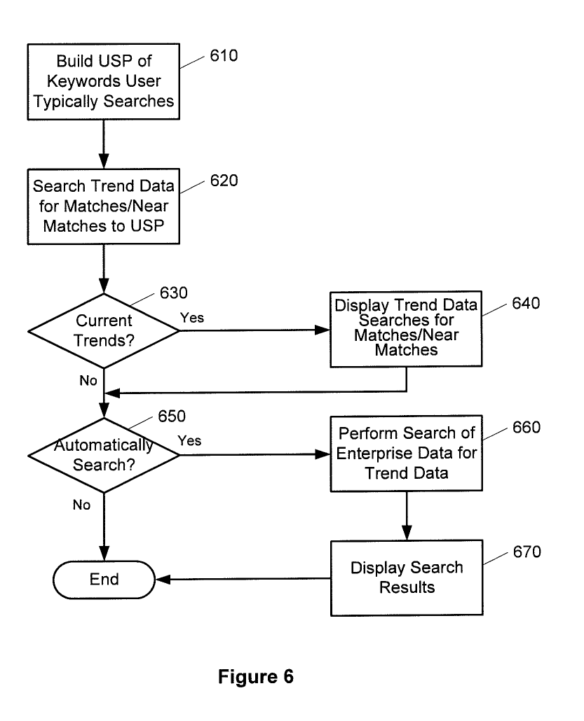

FIG. 6 illustrates generation of a user search profile in conjunction with gathering of current trend information, in accord with embodiments of the present invention. One example of a user search profile is gathering and storing information related to the types of searches (e.g., general subject matter) and words that a user typically searches. The stored search information can be used in a number of ways to enhance either the user's search experience or to inform to someone responding to that user. FIG. 6 illustrates using trend information related to searches by all users to provide anticipatory information to a particular user based upon their user search profile.

A user search profile can be built by collecting key words and phrases that the user typically searches (610). Collection of these search key words and phrases can be done by a process running in the background on a computer that the user typically uses or a process that is started in conjunction with the user logging on. Alternatively, a listening post similar to those discussed above, can also collect such information and identify searches with a particular user who is making a request. User search profile data can then be used to search trend data of all users for matches or near matches to the user's most frequent searches in the user search profile (620). Such a process can be performed, for example, when a user logs on and the user search profile information can be provided to a centralized process that can perform the search of trend data in light of the user search profile (e.g., business intelligence server 230). If there are current trends that correspond to searches in the user search profile (630), results of the matching search trend information can be displayed to the user (640). Such information can be provided, for example, in a dashboard window or similar user interface that a user corresponding to the user search profile will see upon logging on or will be updated during the course of the period the user is logged on. In addition, a user may configure their account to automatically perform the search and pull up information corresponding to their most popular searches in the user search profile (650). If their account is configured in such a manner that search can be performed (660). Once that search is performed, the results of that search can be displayed to the user (670). In this manner, a user can be provided with information pertinent to their most common searches, as defined by the user search profile, without the need for any proactive actions on the part of the user.

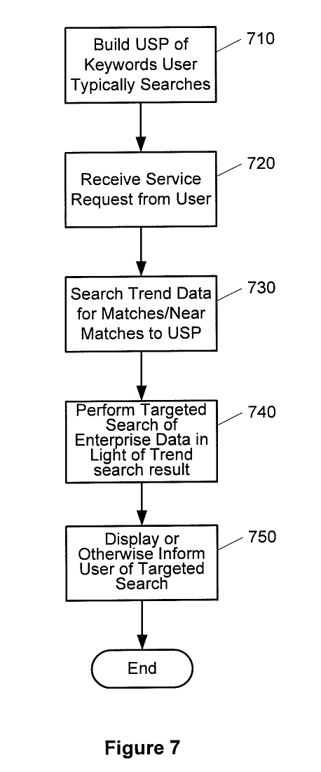

FIG. 7 illustrates an alternative process for utilizing information in a user search profile, in accord with embodiments of the present invention. Again, a user search profile of key words that a user typically searches can be built (710). In this case, the user search profile can be of information that the user searches for the particular enterprise, or can be search information collected by a number of listening posts, as discussed above, but identified with the user. The user associated with the user search profile may subsequently contact the enterprise with, for example, a service request (720). Once the user is identified, trend data stored in data warehouse 225 can be searched for matches to information of importance to the user as indicated by the user search profile (730). A targeted search of documents and other information stored within the enterprise (e.g., in data sources 235, 240, 245 and 250) can be performed in light of the trend data search result (740). The results of that search can be either displayed to the user (e.g., during a web service session) or otherwise be used to inform the user of the results of that targeted session (e.g., during a service or sales support session with an agent of the enterprise) (750). In this manner, the enterprise can anticipate the needs of a user when that user contacts them, and thereby provide information pertinent to the user in a quick and efficient manner. For example, if a user has performed several searches related to a product sold by the enterprise, a sales support representative who is contacted by the user can use that information to target sales of that product to the user. The sales representative could use that information to offer bulk sales prices or other information specific to the product being researched by the user; in this manner closing the sales deal with the user.

Information provided by embodiments of the present invention can be used in a number of ways by an enterprise to provide services and information to users within and outside of the enterprise. Collection of search information from a variety of sources, external and internal to the enterprise, allows the enterprise to generate a significant statistical sample of information generally of interest to users that may impact the enterprise. Collection and analysis of such information allows the enterprise to be responsive to customers, clients, and others. Significant efficiencies can be realized by making more readily available data responsive to trending searches and posts as collected by embodiments of the present invention.

An Example Customer Relationship Management Environment

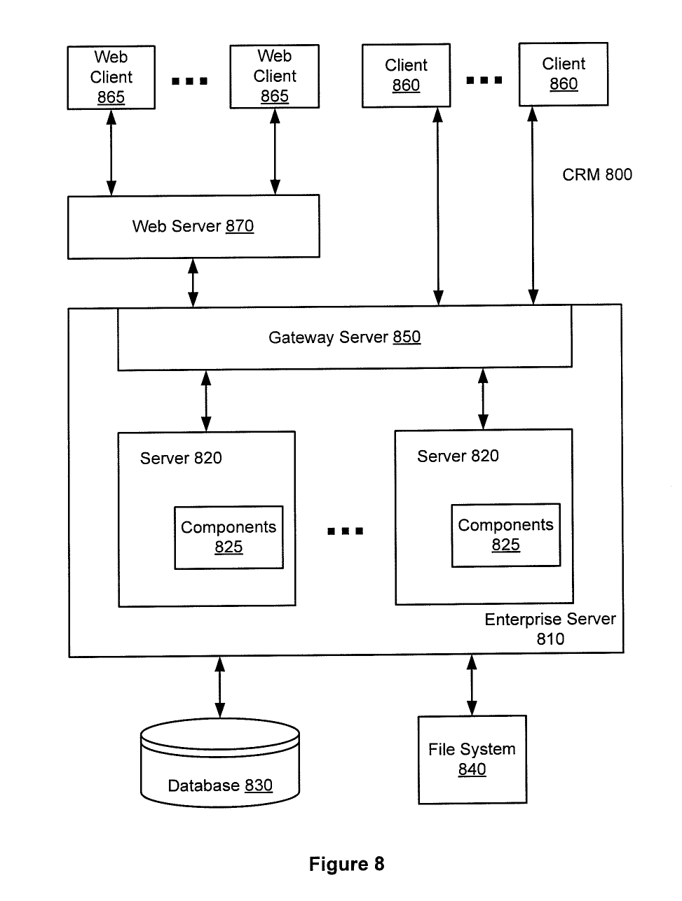

FIG. 8 is a simplified block diagram illustrating a customer relationship management architecture usable in conjunction with embodiments of the present invention. The illustrated customer relationship management environment includes an enterprise server 810 that is a logical grouping of one or more servers 820 that support a group of clients (860, 865) accessing a common database 830. An enterprise server can be configured, managed and monitored as a single logical group, allowing an administrator to start, stop, monitor or set parameters for servers 820 within enterprise server 810. In such a configuration, parameters for the customer relationship management system can be set at the enterprise server level, and these parameters can apply to every server operating within the enterprise server. In addition, other parameters can be adjusted at a server (820) level to support fine tuning of those parameters. In this hierarchical parameter context, if a parameter is set at a server level, then the server-specific value for the parameter can override an enterprise server-level setting for the parameter. Further, parameter settings at a component level (processes executed on servers 820) will override those set at the server level.

Servers 820 can support back-end and interactive processes for each client accessing the server. These processes are illustrated as one or more components 825 within each server. A server 820 can support, for example, multiprocess and multithreaded components, and can operate components in background, batch, and interactive modes. A server component can also operate on multiple servers 820 simultaneously to support an increased number of users or larger batched workloads. Examples of component processes include, for example, mobile web client synchronization, operation of business logic for web clients, connectivity and access to database and file system for clients, integration with legacy or third-party data (e.g., data not native to the CRM system), automatic assignment of new accounts, opportunities, service requests, and other records, and workflow management. Embodiments of the search and updating processes of the present invention can also be implemented to execute on one or more of servers 820 as components.

Servers 820 are coupled to a gateway server 850, illustrated as part of enterprise server 810. Gateway server 850 can coordinate the operations of enterprise server 810 and servers 820. A gateway server can provide persistent storage of enterprise server configuration information, including, for example, definitions and assignments of component groups and components, operational parameters, and connectivity information. A gateway server can also serve as a registry for server and component availability information. For example, a server 820 within enterprise server 810 can notify gateway server 850 of availability. Connectivity information such as network addresses can be stored in a storage accessed by gateway server 850. If a server 820 shuts down or otherwise becomes unavailable, connectivity information related to that server can be cleared from gateway server 850.

Through their relationship in enterprise server 810, servers 820 and their components 825 can access one or more data stores (e.g., databases 830 and file systems 840). Database 830 can store, for example, RDBMS client software and tables, indexes, and data related to all operations impacted by the CRM system. Database information can include, for example, customer information, market data, historical pricing information, current pricing information, contact information, and the like. Similarly, file system 840 can store data and physical files used by clients 860 and 865 and enterprise server 810. File system 840 can be a shared directory, or set of directories on different devices, which is network-accessible to all servers 820 in enterprise server 810. In order for a client to gain access to files in file system 840, a client can connect to an appropriate server 820 to request file uploads or downloads. Server 820 can then access file system 840 using, for example, a file system management component.

As stated above, embodiments of the search and update processes of the present invention can be implemented to execute as components on one or more of servers 820, accessing database 830 to store and retrieve data. An alternative embodiment provides a separate server accessible by the same or different web server.

Clients 860 and 865 provide access to enterprise server 810 for agents using the customer relationship management system. Clients communicate to enterprise server 810 through gateway server 850 either directly (e.g., client 860) or via a web server 870 (e.g., clients 865). A web server 870 can provide a mechanism by which enterprise server 810 can respond to web-based requests (e.g., HTML, XML, and the like). Web clients 865 can include clients coupled to web server 870 via a local area network, metro-area network or wide area network and propagated over a variety of communications media, as discussed above. Further, web clients 865 can include mobile clients accessing web server 870 through wireless communications means. Users of clients 860 and web clients 865 can include, for example, sales agents, service agents, customer representatives, managers of the business entity using the CRM, and the like. Users have access to all information accessible to enterprise server 810 in database 830, as controlled by a user's secured access rights.

Clients 860 and web clients 865 can be distributed throughout an enterprise and can include hundreds or thousands of such clients. Each client can perform tasks related to either creating new records to be stored in, for example, database 830, modifying records in database 830, or searching for information stored in database 830. This large number of requests and entries can create a backlog between entry of the data into database 830 and information related to the created and modified records into a search index associated with database 830.

An Example Computing and Network Environment

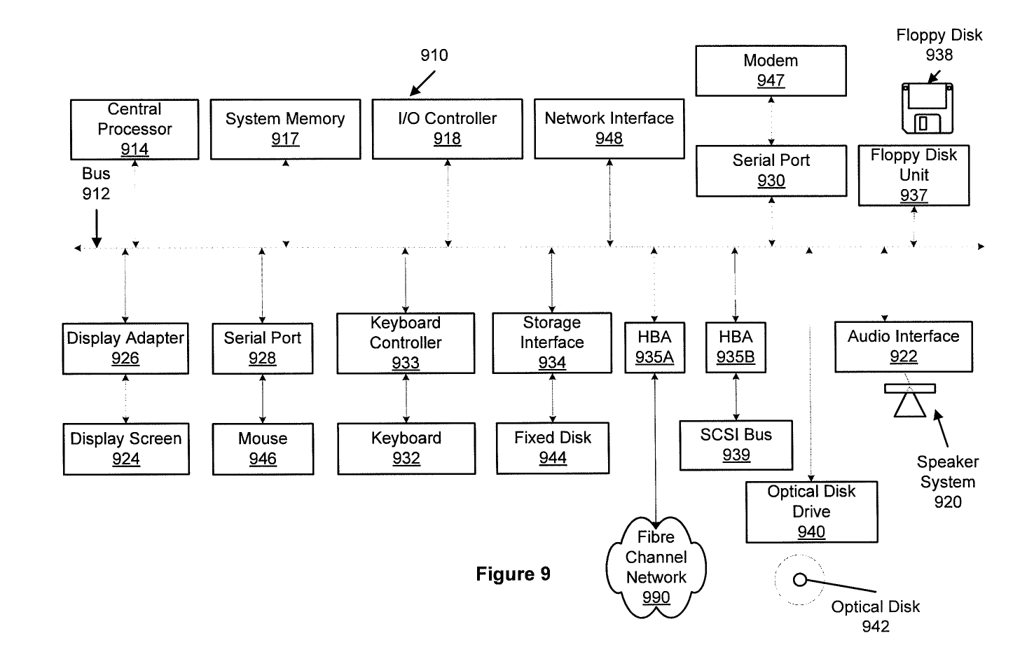

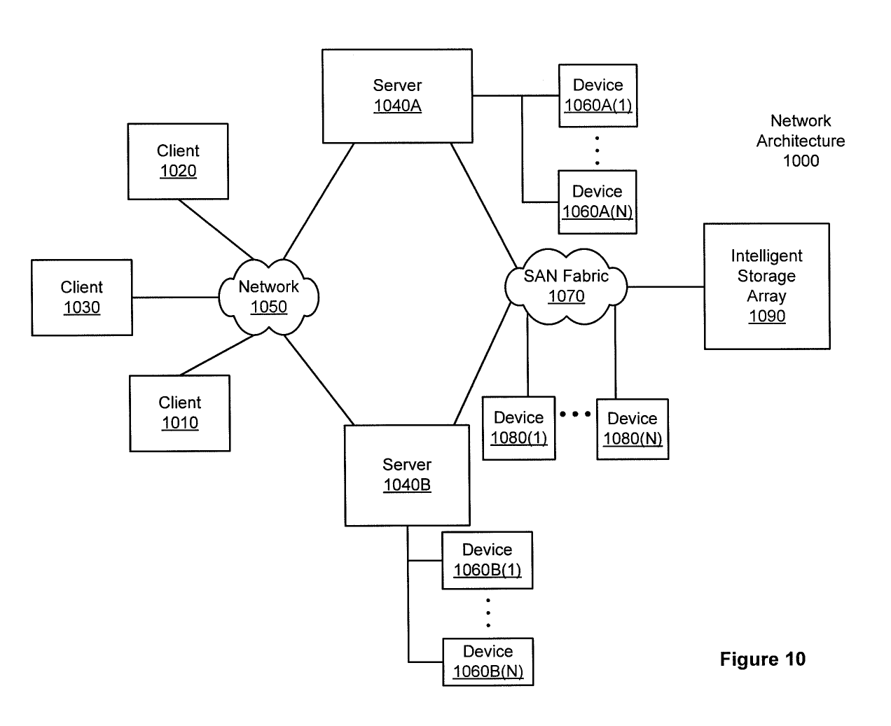

As shown above, the present invention can be implemented using a variety of computer systems and networks. An example of one such computing and network environment is described below with reference to FIGS. 9 and 10.

FIG. 9 depicts a block diagram of a computer system 910 suitable for implementing aspects of the present invention (e.g., data stores 110, analyzer 220, business intelligence server 230, servers 820, gateway server 850, clients 860 and web clients 865). Computer system 910 includes a bus 912 which interconnects major subsystems of computer system 910, such as a central processor 914, a system memory 917 (typically RAM, but which may also include ROM, flash RAM, or the like), an input/output controller 918, an external audio device, such as a speaker system 920 via an audio output interface 922, an external device, such as a display screen 924 via display adapter 926, serial ports 928 and 930, a keyboard 932 (interfaced with a keyboard controller 933), a storage interface 934, a floppy disk drive 937 operative to receive a floppy disk 938, a host bus adapter (HBA) interface card 935A operative to connect with a Fibre Channel network 990, a host bus adapter (HBA) interface card 935B operative to connect to a SCSI bus 939, and an optical disk drive 940 operative to receive an optical disk 942. Also included are a mouse 946 (or other point-and-click device, coupled to bus 912 via serial port 928), a modem 947 (coupled to bus 912 via serial port 930), and a network interface 948 (coupled directly to bus 912).

Bus 912 allows data communication between central processor 914 and system memory 917, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components. Applications resident with computer system 910 are generally stored on and accessed via a computer-readable medium, such as a hard disk drive (e.g., fixed disk 944), an optical drive (e.g., optical drive 940), a floppy disk unit 937, or other storage medium. Additionally, applications can be in the form of electronic signals modulated in accordance with the application and data communication technology when accessed via network modem 947 or interface 948.

Storage interface 934, as with the other storage interfaces of computer system 910, can connect to a standard computer-readable medium for storage and/or retrieval of information, such as a fixed disk drive 944. Fixed disk drive 944 may be a part of computer system 910 or may be separate and accessed through other interface systems. Modem 947 may provide a direct connection to a remote server via a telephone link or to the Internet via an internet service provider (ISP). Network interface 948 may provide a direct connection to a remote server via a direct network link to the Internet via a POP (point of presence). Network interface 948 may provide such connection using wireless techniques, including digital cellular telephone connection, Cellular Digital Packet Data (CDPD) connection, digital satellite data connection or the like.

Many other devices or subsystems (not shown) may be connected in a similar manner (e.g., document scanners, digital cameras and so on). Conversely, all of the devices shown in FIG. 9 need not be present to practice the present invention. The devices and subsystems can be interconnected in different ways from that shown in FIG. 9. The operation of a computer system such as that shown in FIG. 9 is readily known in the art and is not discussed in detail in this application. Code to implement the present invention can be stored in computer-readable storage media such as one or more of system memory 917, fixed disk 944, optical disk 942, or floppy disk 938. The operating system provided on computer system 910 may be MS-DOS®, MS-WINDOWS®, OS/2®, UNIX®, Linux®, or another known operating system.

Moreover, regarding the signals described herein, those skilled in the art will recognize that a signal can be directly transmitted from a first block to a second block, or a signal can be modified (e.g., amplified, attenuated, delayed, latched, buffered, inverted, filtered, or otherwise modified) between the blocks. Although the signals of the above described embodiment are characterized as transmitted from one block to the next, other embodiments of the present invention may include modified signals in place of such directly transmitted signals as long as the informational and/or functional aspect of the signal is transmitted between blocks. To some extent, a signal input at a second block can be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

FIG. 10 is a block diagram depicting a network architecture 1000 in which client systems 1010, 1020 and 1030, as well as storage servers 1040A and 1040B (any of which can be implemented using computer system 910), are coupled to a network 1050. Storage server 1040A is further depicted as having storage devices 1060A(1)-(N) directly attached, and storage server 1040B is depicted with storage devices 1060B(1)-(N) directly attached. Storage servers 1040A and 1040B are also connected to a SAN fabric 1070, although connection to a storage area network is not required for operation of the invention. SAN fabric 1070 supports access to storage devices 1080(1)-(N) by storage servers 1040A and 1040B, and so by client systems 1010, 1020 and 1030 via network 1050. Intelligent storage array 1090 is also shown as an example of a specific storage device accessible via SAN fabric 1070.

With reference to computer system 910, modem 947, network interface 948 or some other method can be used to provide connectivity from each of client computer systems 1010, 1020 and 1030 to network 1050. Client systems 1010, 1020 and 1030 are able to access information on storage server 1040A or 1040B using, for example, a web browser or other client software (not shown). Such a client allows client systems 1010, 1020 and 1030 to access data hosted by storage server 1040A or 1040B or one of storage devices 1060A(1)-(N), 1060B(1)-(N), 1080(1)-(N) or intelligent storage array 1090. FIG. 10 depicts the use of a network such as the Internet for exchanging data, but the present invention is not limited to the Internet or any particular network-based environment.

### Other Embodiments

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

The foregoing describes embodiments including components contained within other components (e.g., the various elements shown as components of computer system 910). Such architectures are merely examples, and, in fact, many other architectures can be implemented which achieve the same functionality. In an abstract but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected,” or “operably coupled,” to each other to achieve the desired functionality.

The foregoing detailed description has set forth various embodiments of the present invention via the use of block diagrams, flowcharts, and examples. It will be understood by those within the art that each block diagram component, flowchart step, operation and/or component illustrated by the use of examples can be implemented, individually and/or collectively, by a wide range of hardware, software, firmware, or any combination thereof, including the specialized system illustrated in FIG. 1.

The present invention has been described in the context of fully functional computer systems; however, those skilled in the art will appreciate that the present invention is capable of being distributed as a program product in a variety of forms, and that the present invention applies equally regardless of the particular type of computer-readable media used to actually carry out the distribution. Examples of computer-readable media include computer-readable storage media, as well as media storage and distribution systems developed in the future.

The above-discussed embodiments can be implemented by software modules that perform one or more tasks associated with the embodiments. The software modules discussed herein may include script, batch, or other executable files. The software modules may be stored on a machine-readable or computer-readable storage media such as magnetic floppy disks, hard disks, semiconductor memory (e.g., RAM, ROM, and flash-type media), optical discs (e.g., CD-ROMs, CD-Rs, and DVDs), or other types of memory modules. A storage device used for storing firmware or hardware modules in accordance with an embodiment of the invention can also include a semiconductor-based memory, which may be permanently, removably or remotely coupled to a microprocessor/memory system. Thus, the modules can be stored within a computer system memory to configure the computer system to perform the functions of the module. Other new and various types of computer-readable storage media may be used to store the modules discussed herein.

The above description is intended to be illustrative of the invention and should not be taken to be limiting. Other embodiments within the scope of the present invention are possible. Those skilled in the art will readily implement the steps necessary to provide the structures and the methods disclosed herein, and will understand that the process parameters and sequence of steps are given by way of example only and can be varied to achieve the desired structure as well as modifications that are within the scope of the invention. Variations and modifications of the embodiments disclosed herein can be made based on the description set forth herein, without departing from the scope of the invention.

Consequently, the invention is intended to be limited only by the scope of the appended claims, giving full cognizance to equivalents in all respects.

What is claimed is:

1. A method comprising:
capturing a search phrase;
analyzing the search phrase for one or more relationships with one or more previously captured search phrases;
generating relationship information from said analysis; and
storing the relationship information in a trend database.

2. The method of claim 1 wherein the search phrase comprises one or more keywords and strings.

3. The method of claim 1 further comprising:
performing said capturing using a first compute node;
filtering, by the first compute node, the search phrase for information of interest, wherein the first compute node is preconfigured with the information of interest; and
transmitting, by the first compute node to a second compute node, the search phrase if said filtering determines the search phrase comprises information of interest.

4. The method of claim 1 further comprising:
performing said analyzing by a second compute node, wherein said analyzing comprises
categorizing the search phrase using categories determined by analyzing the one or more previously captured search phrases,
filtering the search phrase for one or more categories of interest, and
generating trend data for the search phrase in light of said categorizing, if said filtering determines the search phrase contains a category of interest from the one or more categories of interest.

5. The method of claim 4 further comprising:
transmitting by the second compute node to a third compute node, one or more of the trend data and the search phrase; and
storing the one or more of the trend data and the search phrase in a multidimensional database.

6. The method of claim 4 wherein said generating trend data comprises:
generating a score associated with the search phrase, wherein said score is dependent upon a number of categories generated by said categorizing.

7. The method of claim 1 further comprising:
capturing an entry to a website;
analyzing the entry to the website for one or more relationships with one or more previously captured search phrases and entries to websites;
generating relationship information associated with the entry from said analyzing of the entry; and
storing the relationship information in the trend database.

8. The method of claim 7 wherein the entry to the website comprises one of a web log entry, an entry to a web forum, an entry to a network messaging board, and an entry to a network review site.

9. A system comprising:
a first network node configured to
capture a search phrase submitted to a data repository accessible to the first network node, and
transmit the search phrase to a second network node coupled to the first network node via a network; and
a second network node configured to
analyze the search phrase for one or more relationships with one or more previously captured search phrases,
generate relationship information associated with the search phrase from the analyzing of the search phrase, and
store the relationship information in a trend database accessible to the second network node.

10. The system of claim 9 wherein the search phrase comprises one or more keywords and strings.

11. The system of claim 9 wherein the first network node is further configured to:
store a listing of information of interest;
filter the search phrase for the information of interest; and
transmit the search phrase to the second network node if said filtering determines the search phrase comprises information of interest.

12. The system of claim 9 wherein the second network node is further configured to:
perform said analyzing by being further configured to
categorize the search phrase using categories determined from analysis of the one or more previously captured search phrases,
filter the search phrase for one or more categories of interest, and
generate trend data for the search phrase in light of said categorizing, if said filtering determines the search phrase contains a categories of interest from the one or more categories of interest.

13. The system of claim 12 wherein the second network node is further configured to:
store one or more of the trend data and the search phrase in the trend database, wherein the trend database comprises a multidimensional database.

14. The system of claim 12 wherein the second network node is configured to generate the trend data by being further configured to:
generate a score associated with the search phrase, wherein said score is dependent upon a number of categories generated by said categorizing.

15. The system of claim 9 further comprising:
a third network node configured to
capture an entry to a website hosted by the third network node, and
transmit the entry to the second network node, wherein the second network node is coupled to the third network node via the network; and
the second network node is further configured to
analyze the entry for one or more relationships with one or more previously captured search phrases and entries to websites,
generate relationship information associated with the entry from the analyzing of the entry, and
store the relationship information in the trend database.

16. A computer readable storage medium storing instructions executable by a processor, said instructions comprising:
a first set of instructions configured to analyze a search phrase for one or more relationships with one or more previously received search phrases, wherein the search phrase is received from a remote network node, and the search phrase is captured by the remote network node upon being submitted to
a data repository accessible by the remote network node;
a second set of instructions configured to generate relationship information associated with the search phrase from the analyzing of the search phrase; and
a third set of instructions configured to store the relationship information in a trend database.

17. The computer readable storage medium of claim 16 wherein the search phrase comprises one or more keywords and strings.

18. The computer readable storage medium of claim 16 wherein the first set of instructions comprises:
a fourth set of instructions configured to categorize the search phrase using categories determined by analyzing the one or more previously captured search phrases,
a fifth set of instructions configured to filter the search phrase for one or more categories of interest, and
a sixth set of instructions configured to generate trend data for the search phrase in light of said categorizing, if executing the fifth set of instructions determines the search phrase contains one or more categories of interest.

19. The computer readable storage medium of claim 18 wherein the third set of instructions comprises:
a seventh set of instructions configured to store the one or more of the trend data and the search phrase in a multidimensional database.

20. The computer readable storage medium of claim 18 wherein the sixth set of instructions comprises:
a seventh set of instructions configured to generate a score associated with the search phrase, wherein said score is dependent upon a number of categories generated by said categorizing.
